(19) United States
(12) Patent Application Publication
(10) Pub. No.: US 2019/0224778 A1
(43) Pub. Date: Jul. 25, 2019

(54) SYSTEM AND METHOD FOR CUTTING, KISS-CUTTING, SCORING OR PERFORATING MATERIAL

(71) Applicant: ROLLEM LIMITED, South Yorkshire (GB)

(72) Inventors: Stuart MURPHY, Rotherham (GB); Sherif A. IBRAHIM, Rotherham (GB)

(21) Appl. No.: 16/300,518

(22) PCT Filed: May 12, 2017
(86) PCT No.: PCT/GB2017/051339

§ 371 Date: Nov. 9, 2018

(30) Foreign Application Priority Data
May 12, 2016 (GB) 1608381.8

(51) Int. Cl. B23K 26/03; B23K 26/08; B23K 26/38

(52) U.S. Cl. CPC B23K 26/032; B23K 26/38; B23K 26/0876

(57) ABSTRACT

A material processing system comprises a laser, a scanner, a sensor and a processor. The laser is configured to generate a laser beam. The scanner is configured to control the relative position between the laser beam and a material. The sensor is configured to generate an image of the material, wherein the material has a marking representing processing information. The processor is configured to analyse the marking in the image to determine the processing information and control the scanner and the laser to process the material based on the processing information.

### FIELD OF THE INVENTION

The present invention relates to a material processing system, in particular a laser-based material processing system.

### BACKGROUND OF THE INVENTION

When an item (such as a postcard, playing card or business card) is to be printed, it is most time and resource efficient for multiple copies of the item, arranged in a grid, to be printed onto a single sheet of card with the individual items being cut out of the sheet of card after printing.

Cutting out of the individual items is usually done by passing the sheet of card through a print-finishing machine having an array of blades which have been pre-positioned along the cutting paths necessary to cut out the individual items. The fixed array of blades is inflexible, because the array of blades must be positioned in advance and repositioned whenever a different cutting pattern is required.

Instead of using a mechanical blade, a laser can be used to cut the sheet of card into individual items. It is easier to reconfigure the laser to cut different patterns than it is to rearrange the array of blades, and a laser can also cut out complicated patterns having curves and intricate detail which is difficult or impossible using an array of blades.

Packaging is usually manufactured by stamping a package out of a sheet of printed material, such as cardboard or plastic, using a custom-made die. Custom-made dies are expensive to manufacture, meaning that this technique is only really suited to high volume packaging manufacture and is not economically viable for producing small amounts of custom-made packaging, for example, for a small food retailer.

Laser cutting offers a means to produce small quantities of custom-made packaging without the expense of a custom-made die, which allows the packaging to be more easily tailored to a particular application.

However, laser cutting requires detailed processing instructions to be prepared which describe the precise path the laser should follow in order to cut the material, and which indicate whether to cut, score or perforate the material. The detailed processing instructions are usually programmed into software controlling the laser cutter in advance of cutting the material.

The step of programming the processing instructions is time consuming and there is a risk that the wrong instructions could be accidently applied, or that the processing instructions might not be changed before a new cutting job is started, leading to wasted time and materials.

Suitable laser parameters, such as laser scanning speed and laser power, depend on the material being cut. Providing too much power can burn the material, whereas providing too little power may mean that the material is not cut completely which could lead to the material tearing.

The laser parameters need to be programmed into the laser cutter by an operator. However, the operator may not be aware of the appropriate laser parameters, for example, if the operator cannot identify the type of material (which is not easy, for example, with different types of plastic which might require very different laser parameters), or is not aware of the laser parameters that are appropriate for the type of material.

It would, therefore, be advantageous to find an improved way to define processing instructions in a way which is less time consuming and less prone to error and waste, and which does not rely an operator to pick appropriate laser parameters.

### SUMMARY OF THE INVENTION

There is provided a material processing system. The material processing system comprises a laser, a scanner, a sensor and a processor. The laser is configured to generate a laser beam. The scanner is configured to control the relative position between the laser beam and a material. The sensor is configured to generate an image of the material, wherein the material has a marking representing processing information. The processor is configured to analyse the marking in the image to determine the processing information. The processor is also configured to control the scanner and the laser to process the material based on the processing information.

There is further provided a method of processing a material. A laser generates a laser beam; and the relative position between the laser beam and a material is controlled using a scanner. An image of the material is generated using a sensor. The material has a marking representing processing information and, using a processor, the marking in the image is analysed to determine the processing information. The scanner and the laser are controlled, by the processor, to process the material based on the processing information.

There is also provided a method of marking a material comprising applying a marking to a material, wherein the marking represents processing information which enables a scanner and a laser to be controlled in order to process the material based on the processing information.

Analysing the marking in the image to determine the processing information and control the scanner and the laser to process the material based on the processing information eliminates the need for a separate, and time-consuming, step of programming processing information (such as processing instructions or laser parameters) into a material processing system.

As the material comprises a marking representing the processing information, the risk that wrong processing information could be accidently applied by an operator is reduced, and the risk that the processing information might not be changed before a new processing job is commenced is reduced, which helps to reduce wasted time and materials.

The marking may be printed at the same time as printing a sheet of items (such as, postcards, or playing cards). The marking may indicate how the printed sheet is to be cut into individual items. The marking may be printed, along with a packaging design, onto a material that is to be processed into a package.

The processing information may comprise an instruction to cut, score or perforate the material. The marking may comprise a symbol indicating where the material is to be processed, that is, where the material is to be cut, perforated or scored. The marking may comprise a symbol indicating a line along which the material is to be processed. The marking may comprise one or more symbols which define a line along which the material is to be processed. The marking may comprise two or more symbols which in combination define a line along which the material is to be processed. Advantageously, the two or more symbols may be placed in a border region, outside a printed region of the material, such that the symbols are removed from the material during processing so that the symbols do not appear in the processed material.

The marking may be analysed by the processor to determine the type of processing that is to be performed, for example, cutting, scoring or perforating. The colour, shape, or line style of the marking may indicate the type of processing that is to be performed.

The material may have a plurality of markings, for example, a plurality of lines or symbols, where each line or symbol represents that the material is to be cut, perforated or scored.

The marking may comprise a reference marking. A reference marking may be used to identify the position of a printed design on the material, to enable the position of the printed design relative to the material processing system to the calibrated). A reference marking may be used to determine the orientation of the material, so that, for example, it is not necessary to rely on an operator aligning the material on the material processing system in a particular way. The marking may comprise a pair of reference points, to allow for the measurement of, and compensation for, shift and skew in a digital printing process. The pair of reference points may be located on the leading edge of the material. The pair of reference points may be located at opposite sides of the material to make it possible to measure small amounts of shift or skew, without requiring an extremely high resolution sensor.

The processing information may comprise a job identifier. Stored processing information may be retrieved using the job identifier, for example, from a storage medium, server or database. By the material having a marking with a job identifier which allows stored processing information to be retrieved, it can be ensured that the correct processing information is obtained for processing the material. Additionally, when stored processing information is retrieved, it is not necessary to analyse all of the markings on the material again to determine the processing informations, which speeds up processing of the material.

The processing information and associated job identifier may be stored on a storage medium or server. This allows the processing information to be reused in the future, which speeds up future processing of a material having the same marking because it is not necessary to analyse all of the markings of the material again to determine the processing information.

Processing information may comprise one or more laser parameters. This helps to ensure that the correct laser parameters for the material are used for processing the material. For example, the laser parameters may be the laser scanning speed and/or the laser power suitable for the material, thereby preventing too much power being provided (which could burn the material) or too little power being provided (which could mean that the material is not cut completely which could lead to the material tearing). By the processing information including one or more laser parameters, the laser parameters need not be programmed into the material processing system by an operator, saving time and reducing the risk of the operator entering the wrong laser parameters because, for example, the operator is not aware of the correct laser parameters for the material, or the operator incorrectly identifies the material.

The processing information may identify one or more material properties (for example, thickness, name of the material, or type of the material). The processor may determine the one or more laser parameters (such as, laser power, or laser scanning speed) based on the one or more material properties. The laser parameters associated with the one or more material properties may be retrieved from a database. By the processing information indicating the material properties, the correct laser parameters are provided for the material in question without relying on an operator, which speeds up material processing and reduces the likelihood that inappropriate laser parameters are selected which could lead to a burning or damage to the material.

The material may comprise a printed design (such as, a postcard, business card or playing card) and the processor may distinguish the marking representing processing information from the printed design. The processor may distinguish the marking from the printed design based on one or more of: colour, shape, line-style or marking-style of the marking. The colour, shape, line-style or marking-style may be chosen so that they are distinctive and do not appear in the printed design.

The processor may distinguish the marking from the printed design based on the distinctive colour of the marking, for example, by the colour of the marking being a colour that does not appear in the printed design. The processor may identify the marking by finding edges or pixels having the distinctive colour. The processor may fit a cutting line to the edge or pixels.

The sensor may comprise a contact image sensor. A contact image sensor is capable of accurate colour recognition, which enables the distinctive colour of the marking to be distinguished accurately from different colours found in the printed design. The processing information may identify the colour of the marking. The contact image sensor may be colour calibrated (for example, to the printer used to print the coloured design) in order to enable the distinctive colour of the marking to be accurately distinguished from different colours in the printed design.

The printed design may be in a region of the material, and the marking may be in a separate distinct region of the material. For example, the marking may be in a border region of the material, so that the marking will be cut away and not show up in the processed product.

The processor may be configured to analyse the separate distinct region containing the marking and not the region containing the printed design.

The marking may be printed using a medium having an identifiable property, which allows the marking to be readily distinguished from a design printed on the material. For example, the marking may be printed using an ink which fluoresces when illuminated by a light source (such as, an ultraviolet light source). The material processing system may further comprise a light source configured to emit light having a wavelength which causes the ink to fluoresce. The sensor may be sensitive to the fluorescence. An advantage of using an ink which fluoresces is that the ink allows the processing information to be marked on the material in a way which will not be visible under normal illumination, so that the quality of the material is not diminished by the markings. Moreover, where the material comprises a printed design, printing the markings using the ink will not obscure or otherwise diminish the quality of the printed design.

The sensor may comprise a contact image sensor. A contact image sensor may be a better choice than an imaging camera or a line scanning camera because an imaging camera would need to be of very high resolution to image the entire material at sufficient resolution to allow the markings to be successfully analysed and a line scanning camera tends to be expensive and difficult to set-up.

The material processing system may comprise a positioning device, such as a conveyor belt or a translation stage, configured to move the material through the material processing system. A conveyor belt is advantageous because it allows the material processing system to operate continuously without requiring user intervention.

The sensor may be configured to image the material on a line-by-line basis and the positioning device may be configured to scan the material from line-to-line. The processor may be configured to analyse an image of each line individually. An advantage of this is that it is not necessary to wait for the entire image to be captured before the processor begins analysing the image. The processor may begin analysing a line of the image while the sensor is capturing the next line of the image, reducing the time taken to determine the processing information. This is particularly advantageous when using a sensor which captures images on a line-by-line basis, such as a contact image sensor or line scanning camera.

The sensor may be configured to image a plurality of stripes of the material, each stripe comprising a plurality of line scans. The processor may be configured to analyse each stripe individually. A single line may not provide sufficient information to enable the marking to be identified, whereas it wastes time waiting for an image of the whole material to be obtained. Obtaining stripes comprising a plurality of line scans provides a balance, offering sufficient information to identify the markings while being faster than waiting for an image of the whole material.

The material processing system may further comprise one or more rollers configured to improve the flatness of the material. Some sensors, such as a contact image sensor, have a shallow depth of field so it is important to keep the material as flat as possible so that the image remains in focus so the markings can be distinguished.

The scanner may be configured to scan either the laser or the material in order to control the position of the laser beam with respect to the material. For example, the scanner may comprise a pair of scanning mirrors to scan the laser beam. Alternatively, the scanner may comprise a two-axis translation stage to scan the material while the laser beam remains stationary.

The laser may be a CO2 laser, or any other kind of laser suitable for laser processing based on the material to be processed.

The material processing system may further comprise a focusing assembly configured to focus the laser on the surface of the material. The focusing assembly may comprise a lens configured to focus the laser and an actuator configured to adjust the position of the focus.

The material processing system may further comprise an extractor arranged to remove smoke resulting from an interaction between the laser and the material. The extractor removes smoke which may otherwise obscure, or interfere with, the laser (for example, altering the beam path of the laser).

The material may be any material suitable for use in the printing and/or packaging industry. The material may be any material suitable for receiving a printed design. The material may be one of: paper, card, plastic or foil.

### BRIEF DESCRIPTION OF THE DRAWINGS

The present invention shall now be described, by way of example only, with reference to the accompanying drawings in which:

FIG. 1 illustrates a sheet of card with markings indicating cutting lines;

FIG. 2 illustrates a material processing system which analyses the markings on the sheet of card of FIG. 1 to determine the cutting lines and cuts the sheet of card along the cutting lines;

FIG. 3 illustrates a number of markings which indicate the type of cut to be performed by the material processing system of FIG. 2;

FIG. 4 illustrates a sheet of card with markings indicating cutting lines and a barcode representing additional processing information;

FIG. 5 illustrates a sheet of card with a barcode representing processing information; and

FIG. 6 illustrates a sheet of card with markings which are distinguishable from a coloured design.

### DETAILED DESCRIPTION

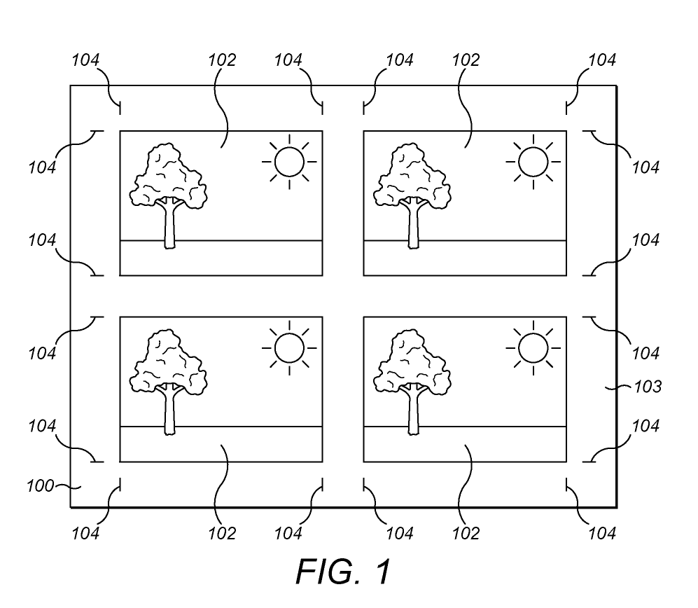

FIG. 1 illustrates a sheet of card 100 which has been printed with four postcards 102 and which now needs to be cut into individual postcards 102. A margin 103 around the edge of the sheet of card 100, which will be cut away and discarded when the postcards 102 are cut into individual postcards 102, contains markings 104. The markings 104 define points along cutting lines where the sheet of card 100 needs to be cut in order to cut out the individual postcards 102.

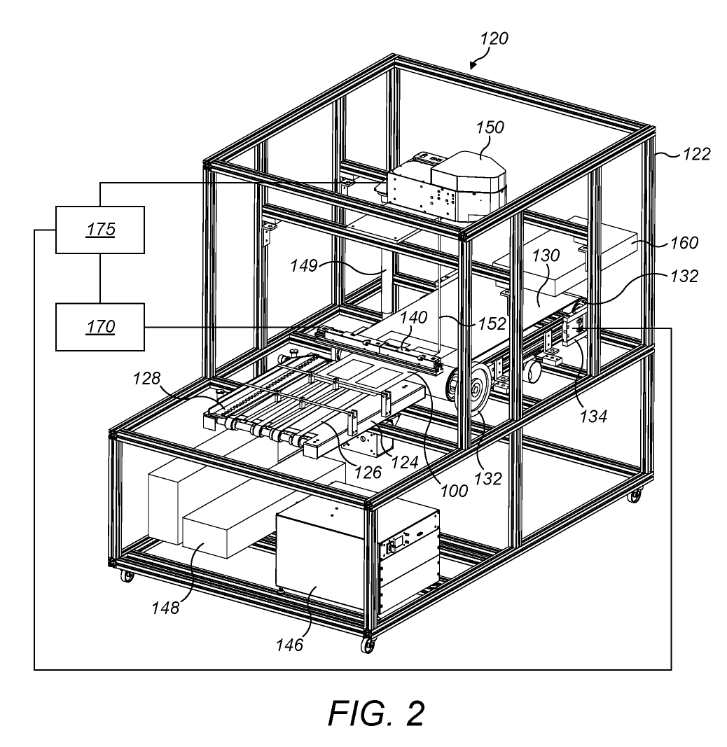

FIG. 2 illustrates a material processing system 120 which can analyse an image of the sheet of card 100, pick out the markings 104 and use the markings 104 to determine the cutting lines. Once the material processing system 120 has determined the cutting lines, the material processing system 120 directs a laser beam 152 to cut the sheet of card 100 along the cutting lines.

The material processing system 120 has a frame 122 which supports a laser head 150 above a conveyor belt 130. The sheet of card 100 is fed onto the conveyor 130 from a registration table 124 which aligns the sheet of card 100 before it passes onto the conveyor 130.

The registration table 124 has a number of rubber belts 126 which run around rollers at either end of the registration table 124. When the sheet of card 100 is placed on the rubber belts 126, the rubber belts 126 urge one side of the sheet of card 100 against an edge 128 in order to place the sheet of card 100 in a known alignment with respect to the conveyor belt 130.

A contact image sensor 140 is positioned above the intersection between the registration table 124 and the conveyor belt 130, so that the sheet of card 100 passes under the contact image sensor 140 as the sheet of card 100 is fed from the registration table 124 onto the conveyor belt 130. The contact image sensor 140 has an array of lenses, where each lens is adjacent to an image pixel of a sensor. As the sheet of card 100 passes under the contact image sensor 140, the contact image sensor 140 can capture a line-by-line image of the whole sheet of card 100.

The output from the contact image sensor 140 is sent to a frame grabber 170 which generates line images of the sheet of card which are sent to processor 175. An encoder 134 on one of the pulleys 132 allows the relative positions of the line images to be determined.

The conveyor belt 130 moves at the same time as the contact image sensor 140 is capturing line images. The contact image sensor 140 has a powerful light which allows an exposure time to be set which avoids, or minimises, blurring of the line images.

The processor 175 analyses each line image as it is received from the frame grabber 175. The processor 175 performs image analysis on each line image to identify any markings 104 present in the line image. A single line image may not be sufficient to identify the markings 104, so the processor 175 may analyse multiple line images.

When the markings 104 have been identified, the processor 175 analyses the markings 140 (for example, by analysing the properties of the marking 104 such as colour, line or marking style) to determine the processing information that the markings 104 indicate. In this case, the image analysis indicates that the markings 104 indicate cutting lines along which the sheet of card 100 is to be cut.

The material processing system 120 has a CO₂ laser which has a laser power supply 146 which generates electrical energy to power the laser 148. The laser 148 emits a laser beam which is directed, via a periscope 149, to the laser head 150. The laser head 150 contains focusing optics to focus the laser beam 152 on the surface of the sheet of card 100. The laser head 150 also contains a pair of scanning mirrors to steer the laser beam 152 under the control of the processor 175.

The scanning mirrors control the position of the laser beam 152 to scan the laser beam 152 across the cutting lines in order to cut the sheet of card 100. The conveyor belt 130 is moving while laser beam 152 is scanning over the sheet of card 100. The output from the encoder 134 indicates the speed at which the conveyor belt 130 is moving. The processor 175 uses the speed information to compensate for the movement of the conveyor belt 130 when controlling the laser beam 152.

The interaction between the laser beam 152 and the sheet of card 100 may lead to smoke as some of the sheet of card 100 is burnt away, so the material processing system 100 has an extractor hood 160 which removes any smoke produced which would otherwise obscure, or interfere with, the laser beam 152.

The markings 104 have been printed on the sheet of card 100 in such a way (using, for example, a style, colour, ink or symbol) which distinguishes the cutting lines 160 from the other printed material on the sheet of card 100 (that is, the four postcards 102).

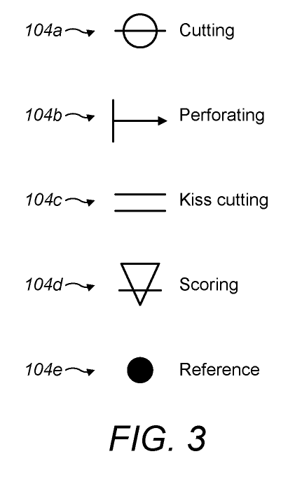

FIG. 3 shows an example of markings 104a-104d which can be used to indicate how the sheet of card 100 should be cut. Marking 104a indicates to perform a cut. Marking 104b indicates to perform a perforation. Marking 104c indicates to perform a kiss cut. Marking 104d indicates to perform scoring.

The markings are sufficiently different that they can be readily distinguished from one another. The processor 175 changes the laser parameters based on the marking so that the different types of cut may be achieved. For example, if the processor 175 identifies marking 104a indicating a cut, the processor 175 sets a higher laser power to fully cut the sheet of card 100 than if the processor 175 identifies marking 104d indicating a score the sheet of card 100 or marking 104c indicating to kiss cut the sheet of card 100. If the processor 175 identifies marking 104b indicating a perforation, the processor 175 pulses the laser 148 in order to form perforations.

A marking can also be used to indicate one or more reference points. Marking 104e is an example of a reference point. A reference point can be used to identify the position of printed material on the sheet of card 100 or to determine the orientation of the sheet of card 100. A pair of reference points may be printed at known locations on the sheet of card 100 to allow for the measurement of, and compensation for, shift and skew in a digital printing process.

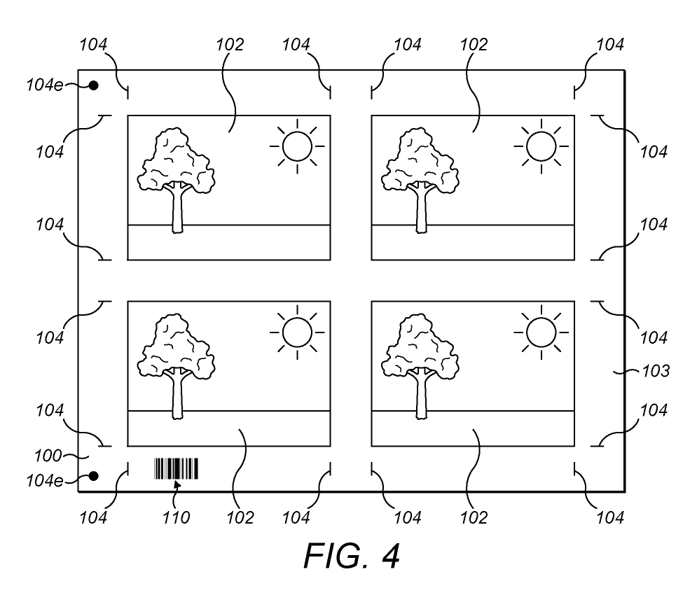

FIG. 4 illustrates a sheet of card 100 like the sheet of card 100 shown in FIG. 1. However, the sheet of card 100 in FIG. 4 has some additional markings: barcode 110 and a pair of reference points 104e. The barcode 110 provides additional processing information to the material processing system 120. The pair of reference points 104e allow the orientation of the sheet of card 100 to be determined and allow for the measurement, and if necessary compensation, of any shift or skew introduced by a digital printing process.

The pair of reference points 104e are located on the leading edge so that the reference points are the first things that the contact image sensor 140 images as the sheet of card 100 is fed from the registration table 124 onto the conveyor belt 130. The pair of reference points are located at opposite sides of the sheet of card 100 to make it possible to measure small amounts of shift or skew without requiring an extremely high resolution contact image sensor 140.

The processor 175 analyses the image of the sheet of card 100 in the same way described in FIG. 2. Again, the processor 175 detects that the sheet of card 100 contains markings 104 which indicate cutting lines along which the sheet of card 100 is to be cut by the laser beam 152.

When analysing the image of the sheet of card 100, the processor 175 detects the pair of reference points 104e which the processor 175 uses to determine the orientation of the sheet of card 100 and to determine whether any shift or skew has occurred during the printing of the postcards 102. If, after analysing the reference points 104e, the processor 175 detects shift or skew has occurred during printing, the processor 175 modifies the path of the laser beam 152 to compensate for the shift or skew.

The processor 175 also detects the barcode 110 when analysing the image. The processor 175 analyses the barcode 110 to determine the code which the barcode 110 represents. The processor 175 retrieves processing information from the database 177 associated with the code.

The processing information includes information about the laser power and laser scanning speed which is appropriate for the material from which the sheet of card 100 is made, and the processor 175 uses the processing information to set the power of the laser 148 and to control the laser scanning speed.

After analysing the image of the sheet of card 100 to determine the cutting lines, the processor 175 may store information about the position and type of the cutting lines in a database along with the associated code. This means that when the code is identified again in the future, the processor 175 need not analyse the images of the sheet of card 140 again to determine the processing instructions.

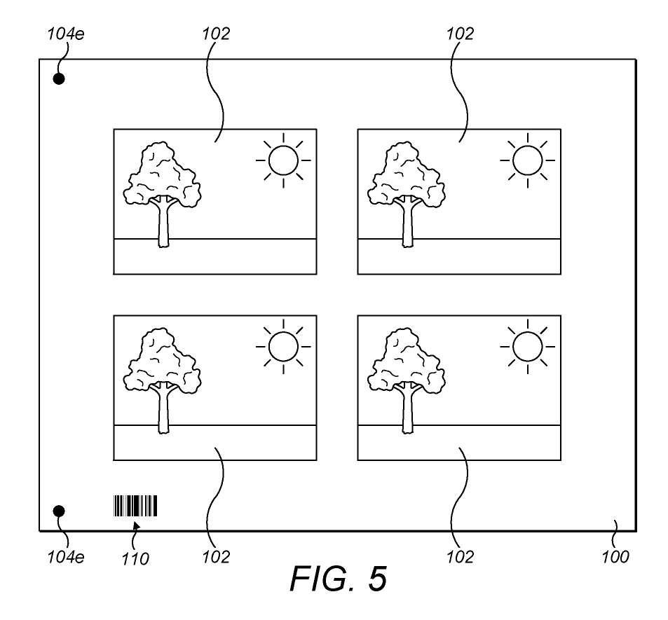

FIG. 5 illustrates a sheet of card 100 which is like the sheet of card 100 in FIG. 4, but without the markings 104. Instead of markings 104, the processing information is contained solely in the barcode 110. The processing information may have been stored when analysing a sheet of card 100 having markings 104 on a previous occasion (as described in FIG. 4), or the processing information may have been entered into the database 177 through other means (such as from a computer aided design program).

When the material processing system 120 analyses the image of the sheet of card 100, the processor 175 detects the barcode 110, which the processor 175 analyses to determine the code represented by barcode 110. The processor 175 retrieves the processing information from the database 177 which is associated with the code.

The processing information includes information about lines along which the sheet of card 100 is to be cut, and the processor 175 directs the laser beam 152 to cut the sheet of card 100 along the lines indicated in the processing information.

The processing information retrieved from the database 177 may also include the laser power and laser scanning speed which is appropriate for the material the sheet of card 100 is made from, and the processor 175 uses the processing information to set the power of laser 148 and to control the scanning speed of the laser beam 152.

The sheet of card 100 also has a pair of reference points 104e at opposite sides of the leading edge of the sheet of card 100. The pair of reference points 104e allow the orientation of the sheet of card 100 to be determined, to align the cutting pattern with the printed material so that it is not necessary to rely on an operator inserting the sheet of card in a particular orientation. The pair of reference points 104e also allow for the measurement, and if necessary compensation, of any shift or skew introduced by a digital printing process which tends to vary from one print to the next.

When analysing the image of the sheet of card 100, the processor 175 detects the pair of reference points 104e which the processor 175 uses to determine the orientation of the sheet of card 100 and to determine whether there is any shift or skew in the position and orientation of the printed postcards 102. If the processor 175 detects shift or skew, the processor 175 modifies the path of the laser beam 152 to compensate for the shift or skew which ensures that the postcards 102 are cut out accurately despite the variability in the digital printing process.

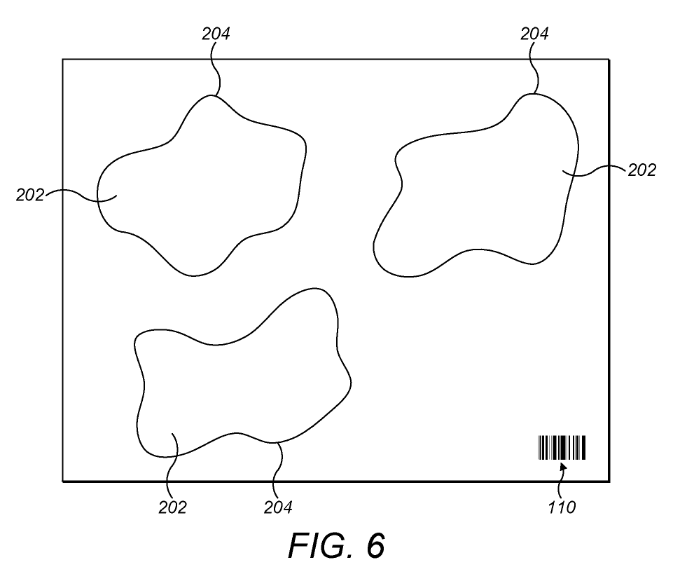

FIG. 6 illustrates another type of marking 204 which can be used to indicate how the sheet of card 100 is to be cut. The marking 204 is especially suitable for indicating a complex cutting pattern.

The markings 204 are printed around the outline of shapes 202 which are to be cut out of a sheet of card 110. A coloured design has been printed onto the shapes 202 and the markings 204 are distinguishable from the coloured design by being printed in a distinctive colour which has been selected to be a colour which does not appear in the coloured design. A barcode 110 on the sheet of card 110 indicates the distinctive colour of the markings 204.

The contact image sensor 140, which has at least 8-bit colour resolution and has been colour calibrated to the printer which printed the coloured design, is able to identify the distinctive colour of the marking 204. The processor identifies pixels or edges of the distinctive colour in an image, and fits a cutting line to the pixels or edges. The processor 175 controls the laser head 150 to scan the laser beam 152 along these cutting lines in order to cut out the shapes 202.

If it is desired to prevent the markings 204 from showing around the edge of the shape 212, the processor 175 may control the laser beam 152 to cut on the inside of the marking 204 so that the entire marking 204 is cut away from the shape 202.

Instead of using colour, the marking 204 could instead be distinguished from the coloured design by being printed using an ink which fluoresces when illuminated, for example, under UV light. A filter could be placed over the contact image sensor 140 which would mean that the contact image sensor 140 would only pick up the image of the marking 204 and not the coloured design.

Although the invention has been described in terms of certain preferred embodiments, the skilled person will appreciated that various modifications could be made without departing from the scope of the appended claims.

The material processing system 120 has been described as having a contact image sensor 140. However, the material processing system 120 could have any kind of sensor that can image the sheet of card 100 and can allow markings 104 or 204 to be identified, and distinguished, by the processor 175 from other printed material on the sheet of card 100. For example, an imaging camera or a line scanning camera could be used.

The conveyor belt 130 may scan the sheet of card 100 multiple times under the contact image sensor 100, for example, if the processor 175 requires further information to determine the position or type of the markings 104 or 204.

Instead of a conveyor belt 130, the material processing system 120 could have any device to move the sheet of card 100, such as a linear translation stage. Alternatively, the sheet of card 100 could be fixed and the contact image sensor (or other sensor) could be scanned across the material.

The contact image sensor 140 is placed in close contact with the material, touching or almost touching, and a pair of rollers may hold the material flat to keep the surface of the material in focus as the depth of field of the contact image sensor 140 tends to be shallow.

Although the markings have been described in terms of cutting lines which indicate the lines along which the sheet of card 100 is to be cut, the markings could some other kind of processing, such as perforating, kiss cutting or scoring.

The database may be on a server which the processor 175 access across a network.

Instead of a barcode 110, a QR code or any other kind of machine readable representation of data could be used.

Rather than the processing information associated with the code including information about the laser power and laser scanning speed, the processing information associated with the code could identify the material of the sheet of card 100. The material may then be looked up in a database to identify laser parameters, such as laser power and laser scanning speed, which are suitable for the material.

FIG. 3 shows examples of markings 104a-104d which could be used to represent various different types of cut. Different shaped markings could be used to represents each of these kinds of cut, as long as each of the markings 104a-104d can be readily distinguished from one another by the processor 175. FIG. 3 shows an example of using a filled circle to represent reference point 104e. However, instead of a filled circle, any shaped marking can be used to represent a reference point as long as the marking chosen for the reference point can be distinguished from the markings 104a-104d representing the various kinds of cut, and as long as the marking chosen provides sufficient accuracy and resolution as a reference point, for example, the marking is sufficiently large and well defined to allow skew and shift to be measured.

The invention has been described in terms of a sheet of card 100. However, the invention is equally applicable to any material that is suitable for use in the printing or packaging industry, including, paper, fabric, cardboard and foil.

Instead of a CO₂ laser, any laser that is suitable for laser cutting, scoring and/or perforating may be used. The laser may be selected based on the material that is to be processed.

1. A material processing system comprising:
a laser configured to generate a laser beam;
a scanner configured to control the relative position between the laser beam and a material;
a sensor configured to generate an image of the material, wherein the material has a marking representing processing information; and
a processor configured to:
analyse the marking in the image to determine the processing information; and
control the scanner and the laser to process the material based on the processing information.

2. The material processing system of claim 1, wherein the processing information comprises an instruction to cut, kiss-cut, score or perforate the material.

3. The material processing system of claim 1, wherein the processing information comprises a job identifier.

4. The material processing system of claim 3, wherein the processor retrieves stored processing information using the job identifier.

5. The material processing system of claim 3, wherein the processor stores the determined processing information along with the job identifier.

6. The material processing system of claim 1, wherein the processing information comprises one or more laser parameters.

7. The material processing system of claim 1, wherein the processing information comprises one or more material properties.

8. The material processing system of claim 7, wherein the processor determines laser power and/or laser scanning speed based on the one or more material properties.

9. The material processing system of claim 1, wherein the material comprises a printed design, and the processor distinguishes the marking representing the processing information from the printed design.

10. The material processing system of claim 9, wherein the processor distinguishes the marking from the printed design based on the colour of the marking, and
the colour of the marking is a colour not found in the printed design.

11. (canceled)

12. The material processing system of claim 9, wherein the printed design is on a region of the material, and the marking is on a separate distinct region of the material.

13. (canceled)

14. The material processing system of claim 12, wherein the processor is configured to analyse the separate distinct region containing the marking and not the region containing the printed design.

15. The material processing system of claim 1, wherein:
the marking is printed using a medium which fluoresces when illuminated by a light source;
the material processing system further comprises a light source configured to emit light having a wavelength which causes the ink to fluoresce; and
the sensor is sensitive to the fluorescence.

16. The material processing system of claim 1, wherein the sensor comprises a contact image sensor.

17. The material processing system of claim 1, wherein the sensor is configured to image a plurality of stripes of the material, each stripe comprising a plurality of line scans, and the processor is configured to analyse each stripe individually.

18. The material processing system of claim 1, further comprising one or more rollers configured to improve the flatness of the material.

19. The material processing system of claim 1, wherein the scanner is configured to scan either the laser or the material in order to control the relative position between the laser beam and the material.

20. The material processing system of claim 1, further comprising an extractor arranged to remove smoke resulting from an interaction between the laser and the material.

21. A method of processing a material comprising:
generating a laser beam using a laser;
controlling the relative position between the laser beam and a material using a scanner;
generating an image of the material using a sensor, wherein the material has a marking representing processing information; and
analysing the marking in the image with a processor to determine the processing information; and
controlling the scanner and the laser using the processor, to process the material based on the processing information.

22. A method of marking a material comprising:
applying a marking to a material, wherein the marking represents processing information which enables a scanner and a laser to be controlled in order to process the material based on the processing information.
